(19) United States
(12) Patent Application Publication
(10) Pub. No.: US 2022/0042206 A1
(43) Pub. Date: Feb. 10, 2022

(54) PARTICLE-COATED FIBER AND METHOD FOR FORMING THE SAME

(71) Applicant: Nano and Advanced Materials Institute Limited, Hong Kong (CN)

(72) Inventors: Ho Wang TONG, Hong Kong (CN); Huajia DIAO, Hong Kong (CN); Chun Yin Karl YIP, Hong Kong (CN)

(21) Appl. No.: 17/249,297

(22) Filed: Feb. 26, 2021

Related U.S. Application Data
(60) Provisional application No. 62/706,200, filed on Aug. 5, 2020.

(51) Int. Cl. D01D 5/00; C08G 63/08; C08F 20/44; B05D 1/00

(52) U.S. Cl. CPC D01D 5/0038; B05D 1/007; C08F 20/44; C08G 63/08

(57) ABSTRACT

The present invention provides a particle-coated fiber comprising a fiber and particles coated on the fiber, and a method for forming the same. The method comprises: providing a suspension comprising the particles; providing a polymer solution for forming the fiber; electrospraying the suspension toward an area of a collector; and during the electrospraying of the suspension, electrospinning the polymer solution into the fiber and directing the fiber toward the area so as to meet with the suspension on the area and on the way to the area such that the particles are coated on the fiber during and after the formation of the fiber thereby forming the particle-coated fiber on the area. By the present method, the particles can be crowed on the surface of the fiber, and the adhesiveness between the fiber and the particles can be substantially enhanced.

### CROSS-REFERENCE TO RELATED APPLICATIONS

This application claims the benefit of U.S. Provisional Patent Application No. 62/706,200, filed on Aug. 5, 2020, which is incorporated by reference herein in its entirety.

### TECHNICAL FIELD

The present disclosure relates to a particle-coated fiber and method for forming the same.

### BACKGROUND

Some microparticles especially inorganic microparticles are commonly used for removing the undesirable or harmful gases. However, when practically applied, several limitations for these inorganic microparticles are found as follows.

The first limitation is poor scalability. Metal and metal oxides are desirable candidate materials for catalytic applications, such as gas conversion. But incorporation of metal/metal oxides into organic polymer-based nanofibers is challenging, especially when it comes to mass production. These challenges could be due to compatibility, stability and solubility of their precursor such as metal salts or metal alkoxides, which are always used as raw materials for subsequent processing. To date, nearly all inorganic nanofibers are manipulated from the sintering of their precursors. During the sintering process, the precursor fibers typically undergo three phases. In phase one, residual solvents and water vapors are removed from the fibers. In phase two, the organic materials are removed and actual fiber shrinkage takes place, followed by polymerization, condensation and structural relaxation of inorganic materials. In phase three, inorganic materials enter the glass transition stage. Typically, sintering of electrospun inorganic nanofiber is a very slow process, which limits the potentials of scale-up in industrial applications.

The second limitation is poor mechanical property. In practical applications, inorganic microparticles are often used in the form of inorganic metal oxide fibers for better handling. However, there inorganic metal oxide fibers are usually produced via condensations of metal organic precursors or metallic salts, which belong to the hydrolytic and non-hydrolytic sol-gel chemistry. After sol-gel polymerization, the high porosity of inorganic fiber induces low elastic modulus and toughness. Another way of fabricating inorganic fibers is electrospinning. By utilizing electrospinning and a subsequent calcination process, various inorganic nanofibrous membranes have been developed. However, it has to be noticed that the sintering process always leads to shrinkage of the fibers owing to the removal of polymer template. Because of their thinner section and the internal stress generated by the shrinkage, most inorganic nanofiber samples are very brittle and the expected flexibility has not been observed. Their brittleness limits their practical applications.

The third limitation is low exposure of microparticles. Electrospinning a mixture of inorganic micro-/nano-particles and organic polymer solution is the simplest way to make inorganic/organic hybrid nanofibers. When the organic polymer solution is stretched into nanofiber jets, functional inorganic particles will also be injected together. However, this kind of multi-component nanofiber is impeded because of poor solubility, dispersion and stability of inorganic particles. Compelling evidences have previously revealed that, during the synthesis of multi-component nanofibers, unspinnable precipitates of inorganic particles significantly impeded the reactivity of the final hybrid product. During electrospinning, it is difficult to control where the particles will locate. In most cases, a large portion of particles tend to hide inside the nanofiber while only a small portion on the surface of nanofiber which serve as workable particles. These particles will function only when they are exposed to the targets such as VOCs. Therefore, simple mixing of multiple components such as organic and inorganic part might not necessarily meet the desirable multiple functional requirements. Such complexity demanded both strategic structural design and deliberate fabrication methods.

Most nanofiber membranes are fabricated by electrospinning of organic polymers. The function of organic nanofiber is limited to removing substances by size only. For example, it has been using as membrane filter for filtering air. Regarding to this application, taking the advantages of highly porous, small pore size and high surface-to-volume ratio, nanofiber is used for removing small particulate such as dust and PM2.5, while allowing all gaseous to pass through. This relies mainly on the size exclusion nature of nanofiber. Nevertheless, this still could not remove any undesirable gases such as ethylene and VOCs as they are too small to be trapped by the pores on nanofibers.

There are various ways to control gaseous compounds, including adsorption and chemical conversion. However, for any approaches to remove the gaseous compounds, the use of inorganic materials is unavoidable.

A need therefore exists for a new particle-coated fiber and method for forming the same that eliminates or at least diminishes the disadvantages and problems described above.

### SUMMARY

Provided herein is a method for forming a particle-coated fiber, the particle-coated fiber comprising a fiber and particles coated on the fiber, the method comprising: providing a suspension comprising the particles; providing a polymer solution for forming the fiber; electro spraying the suspension toward an area of a collector; and during the electrospraying of the suspension, electrospinning the polymer solution into the fiber and directing the fiber toward the area so as to meet with the suspension on the area and on the way to the area such that the particles are coated on the fiber during and after the formation of the fiber thereby forming the particle-coated fiber on the area.

In certain embodiments, the step of electrospraying the suspension toward the area comprises a spraying direction having an angle between 50° and 70° with respect to a direction from a container for containing the polymer solution to the area.

In certain embodiments, the step of electrospraying the suspension toward the area comprises using one or more spraying devices to electrospray the suspension toward the area.

In certain embodiments, each of the one or more spraying devices is configured to have a spraying direction having an angle between 50° and 70° with respect to a direction from a container for containing the polymer solution to the area.

In certain embodiments, the step of electrospraying the suspension toward the area comprises applying a voltage between a spraying device containing the suspension and the area.

In certain embodiments, the polymer solution is electrospun into the fiber by free-surface electrospinning or needle-type electrospinning.

In certain embodiments, the step of electrospinning the polymer solution into the fiber comprises: rotating a drum partially immersed in the polymer solution; and applying a voltage between the drum and the area.

In certain embodiments, the step of electrospinning the polymer solution into the fiber and directing the fiber to the area comprises: applying a voltage between the polymer solution and the area.

In certain embodiments, the method further comprises generating an airflow between a container for containing the polymer solution and the area.

In certain embodiments, the airflow has an airflow direction being in parallel with the area.

In certain embodiments, the airflow moves back and forth along the airflow direction.

In certain embodiments, the method further comprises moving the collector.

In certain embodiments, the collector is moved by an unwinding/rewinding system.

In certain embodiments, the collector is an aluminum foil, an antistatic nonwoven or a siliconized paper.

In certain embodiments, the step of providing the suspension comprises dispersing the particles in a solvent.

In certain embodiments, each of the particles is inorganic, has a diameter between 1 and 100 μm and comprises a gas absorbent or a catalyst.

In certain embodiments, the polymer solution is prepared by dissolving a polymer or a blended of polymers in a solvent or a mixture of solvents.

In certain embodiments, the polymer solution comprises polyacrylonitrile, poly(vinylidene fluoride), poly(vinylidene fluoride-co-hexafluoropropylene), polyvinylpyrrolidone, poly(vinyl alcohol), poly(ethylene oxide), polysulfone, polyethersulfone, poly(methyl methacrylate), or polyurethane, polyamide 6.

Provided herein is a particle-coated fiber being formed by the method above.

Provided herein is a method for forming a scaffold of particle-coated fibers, each of the particle-coated fibers comprising a fiber and particles coated on the fiber, the method comprising: providing a suspension comprising the particles; providing a polymer solution for forming the fibers; electrospraying the suspension toward an area of a collector; and during the electrospraying of the suspension, electrospinning the polymer solution into the fibers and directing the fibers toward the area so as to meet with the suspension on the area and on the way to the area such that the particles are coated on the fibers during and after the formation of the fibers thereby forming the scaffold.

Provided herein is a scaffold of particle-coated fibers being formed by the method above.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects of the present invention are disclosed as illustrated by the embodiments hereinafter.

### BRIEF DESCRIPTION OF DRAWINGS

The appended drawings, where like reference numerals refer to identical or functionally similar elements, contain figures of certain embodiments to further illustrate and clarify the above and other aspects, advantages and features of the present invention. It will be appreciated that these drawings depict embodiments of the invention and are not intended to limit its scope. The invention will be described and explained with additional specificity and detail through the use of the accompanying drawings in which:

FIG. 1 is flow chart depicting a method for forming a particle-coated fiber according to certain embodiments;

FIG. 2 is flow chart depicting a method for forming microparticle-coated nanofiber according to certain embodiments;

FIG. 3 is a schematic drawing depicting a system for fabricating a scaffold of microparticle-coated nanofibers according to certain embodiments;

FIG. 4A is a SEM image showing a zeolite microparticle-corwded polycaprolactone nanofibers at high magnification according to certain embodiments;

FIG. 4B is a SEM image showing the zeolite microparticle-corwded polycaprolactone nanofibers of FIG. 4A at low magnification;

FIG. 5A shows a TGA result by a microparticle-coated nanofibrous membrane before ethylene removal according to certain embodiments;

FIG. 5B shows a TGA result by the microparticle-coated nanofibrous membrane after ethylene removal;

FIG. 6A shows a TGA result by a microparticle-coated nanofibrous membrane before formaldehyde conversion according to certain embodiments;

FIG. 6B shows a TGA result by the microparticle-coated nanofibrous membrane after the formaldehyde conversion; and

FIG. 7 depicts an experimental set-up for ethylene removal test according to certain embodiments.

Skilled artisans will appreciate that elements in the figures are illustrated for simplicity and clarity and have not necessarily been depicted to scale.

### DETAILED DESCRIPTION OF THE INVENTION

It will be apparent to those skilled in the art that modifications, including additions and/or substitutions, may be made without departing from the scope and spirit of the invention. Specific details may be omitted so as not to obscure the invention; however, the disclosure is written to enable one skilled in the art to practice the teachings herein without undue experimentation.

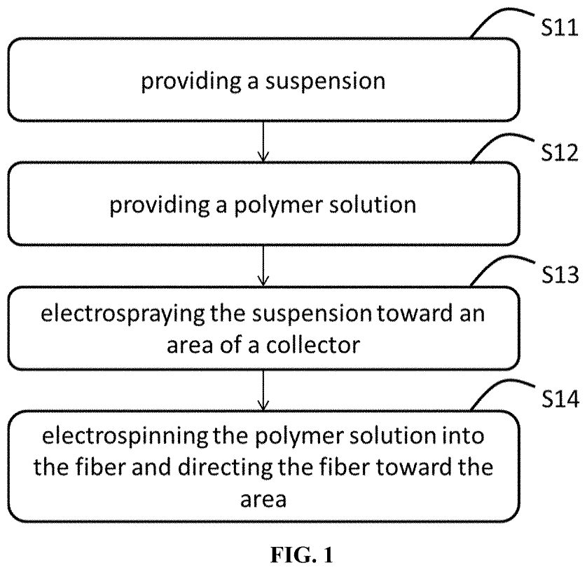

FIG. 1 is flow chart depicting a method for fabrication a particle-coated fiber according to certain embodiments. In step S11, a suspension comprising particles is provided. In step S12, a polymer solution for forming a fiber is provided. In step S13, the suspension is electrosprayed toward an area of a collector. In step S14, during the electrospraying of the suspension, the polymer solution is electrospun into the fiber and the fiber is directed toward the area so as to meet with the suspension on the area and on the way to the area such that the particles are coated on the fiber during and after the formation of the fiber thereby forming the particle-coated fiber on the area.

In certain embodiments, the step of electrospraying the suspension toward the area comprises a spraying direction having an angle between 50° and 70° with respect to a direction from a container for containing the polymer solution to the area.

In certain embodiments, the step of electrospraying the suspension toward the area comprises using one or more spraying devices to electrospray the suspension toward the area.

In certain embodiments, each of the one or more spraying devices is configured to have a spraying direction having an angle between 50° and 70° with respect to a direction from a container for containing the polymer solution to the area.

In certain embodiments, wherein the step of electrospraying the suspension toward the area comprises applying a voltage between a spraying device containing the suspension and the area.

In certain embodiments, the polymer solution is electrospun into the fiber by free-surface electrospinning or a needle-type electrospinning.

In certain embodiments, the step of electrospinning the polymer solution into the fiber comprises: rotating a drum partially immersed in the polymer solution; and applying a voltage between the drum and the area.

In certain embodiments, the step of electrospinning the polymer solution into the fiber comprises: rotating a drum partially immersed in the polymer solution; and applying a voltage between the drum and the area.

In certain embodiments, the step of electrospinning the polymer solution into the fiber and directing the fiber to the area comprises: applying a voltage between the polymer solution and the area.

In certain embodiments, the method further comprises generating airflow between a container for containing the polymer solution and the area.

In certain embodiments, the airflow has an airflow direction being in parallel with the area.

In certain embodiments, the airflow moves back and forth along the airflow direction.

In certain embodiments, the method further comprises moving the collector.

In certain embodiments, the collector is an aluminum foil, an antistatic nonwoven or a siliconized paper.

In certain embodiments, the step of providing the suspension comprises dispersing the particles in a solvent.

In certain embodiments, each of the particles is inorganic, has a diameter between 1 and 100 μm and comprises a gas absorbent or a catalyst.

In certain embodiments, the polymer solution is prepared by dissolving a polymer or a blended of polymers in a solvent or a mixture of solvents.

In certain embodiments, the polymer solution comprises polyacrylonitrile, poly(vinylidene fluoride), poly(vinylidene fluoride-co-hexafluoropropylene), polyvinylpyrrolidone, poly(vinyl alcohol), poly(ethylene oxide), polysulfone, polyethersulfone, poly(methyl methacrylate), or polyurethane, polyamide 6.

According to the method described above, as the particles are not mixed with the polymer solution, the particles can be substantially crowded on the surface of the fiber, instead of being embed in the fiber.

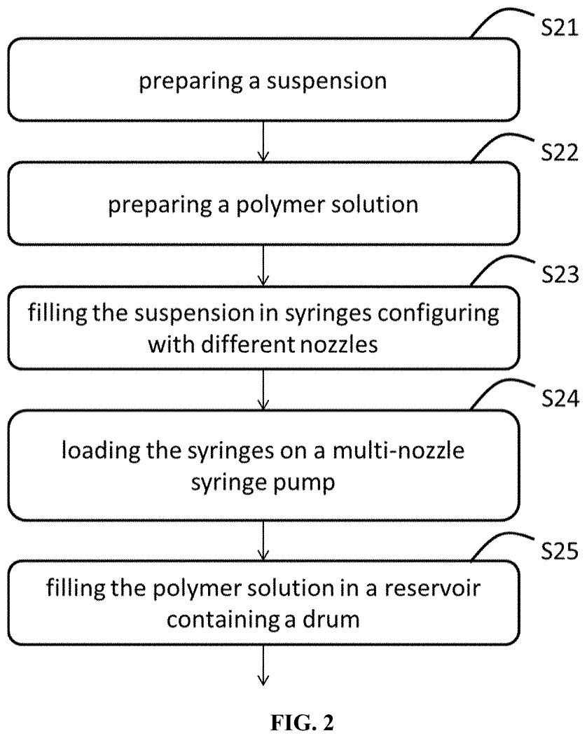

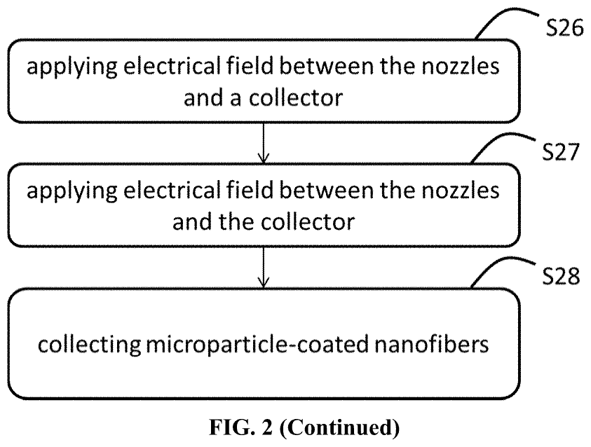

FIG. 2 is flow chart depicting a method for forming microparticle-coated nano fibers according to certain embodiments. In step S21, a suspension is prepared by dispersing inorganic microparticles in organic solvents with fast evaporation rate. In step S22, a polymer solution is prepared by dissolving a polymer or a blend of polymers in a solvent or a mixture of solvents. In step S23, the suspension is filled in syringes configuring with different nozzles. In step S24, the syringes are loaded on a multi-nozzle syringe pump for electrospraying. In step S25, the polymer solution is filled in a reservoir containing a drum. In step S26, an electrical field is applied between the nozzles and a collector for electrospraying the suspension toward an area of the collector. In step S27, an electrical field is applied between the rotating drum and the collector for electrospinning the polymer solution from the reservoir into nanofibers and the nanofibers are directed toward the area of the collector. In step S28, the microparticle-coated nanofibers are collected on the collector.

In certain embodiments, the inorganic microparticles are collected onto the collector first by electrospraying, followed by forming a scaffold of nanofibers on the collector by electrospinning, and then further to electrospray the microparticles onto the scaffold such that the scaffold serving as a holder for holding the inorganic microparticles are sandwiched between inorganic microparticles, and both of the upper surface and the lower surface of the scaffold are crowded with the inorganic microparticles.

In certain embodiments, the free-surface electrospinning is used for forming the fibers in the present method so as to improve the productivity in mass production and the homogeneity of the fibers.

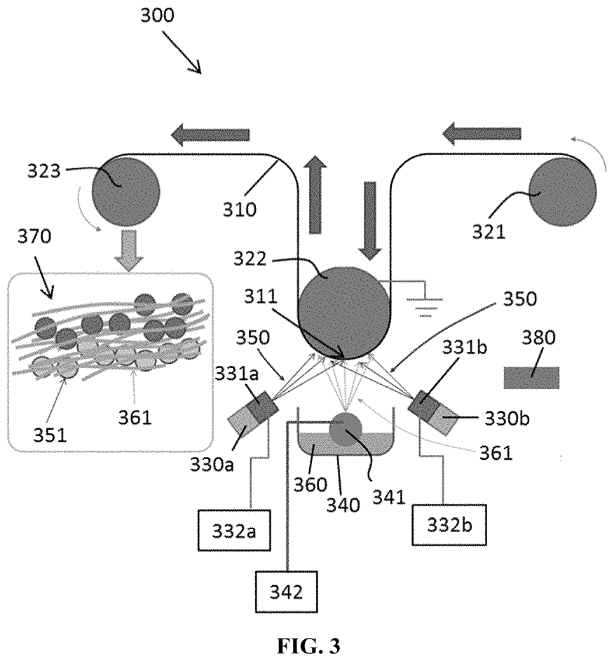

FIG. 3 is a schematic drawing depicting a system 300 for fabricating a microparticle-coated nanofibers according to certain embodiments. The system 300 comprises a roll of substrate 310 (i.e., an example of the collector), an unwinding/rewinding system 320, two syringes 330a, 330b, a reservoir 340 and a drum 341. The roll of substrate 310 can be an aluminium foil, an antistatic nonwoven, a siliconized paper, or etc. The unwinding/rewinding system 320 comprises an unwinding cylinder 321, a collecting cylinder 322 and a rewinding cylinder 323. The syringe 330a has a nozzle 331a connecting to a power supply 332a and the syringe 330b has a nozzle 331b connecting to a power supply 332b. The drum 341 is connected to a power supply 342 and located in the reservoir 340. The two syringes 330a, 330b and the reservoir 340 are located below the collecting cylinder 322. The syringe 330a is located at the left side of the reservoir 340 and has a spraying direction having an angle respect to a direction from the reservoir 340 to the collecting cylinder 322. The syringe 330b is located at the right side of the reservoir 340 and has a spraying direction having an angle respect to a direction from the reservoir 340 to the collecting cylinder 322.

The roll of substrate 310 is loaded onto the unwinding/rewinding system 320 and moved along the unwinding cylinder 321, the collecting cylinder 322 and the rewinding cylinder 323. A suspension 350 containing inorganic microparticles 351 is loaded into the syringes 330a, 330b. The reservoir 340 is filled with a polymer solution 360 such that the drum 341 is partially immersed in the polymer solution 360. An electrical field is applied between the collecting cylinder 322 and the group of nozzles 331a, 331b by the power supplys 332a, 332b for spraying the suspension 350 onto an area 311 of the roll of substrate 310 below the collecting cylinder 322. During the spraying of the suspension 350, the drum 341 is rotated and an electrical field is applied between the collecting cylinder 322 and the rotating drum 341 by the power supply 342 to electrospin the polymer solution into nanofibers 361 and directing the nanofiber 361 to the area 311 so as to meet with the suspension 350 such that the microparticles 351 are securely coated on the nanofibers 361 during and after the formation of the nanofiber 361. As a result, microparticle-coated nanofibers 370 are continuously formed on the roll of substrate 310 by these simultaneous electrospinning and electrospraying.

In certain embodiments, an air blower 380 is used to generate airflow between the area 311 and the reservoir 341. The direction of the airflow can reverse from left to right and then from right to left alternately, thus increasing the overall length of the spiraling path of the electrospun polymer solution jet between the reservoir 341 and the area 311 before solidification of the polymer jet into nanofiber. The airflow can increase the chance of trapping microparticles within the nanofiber matrix.

In certain embodiments, 1-8, or preferably 4-5, of nozzles are used for spraying the microparticles to optimize the density and uniformity of microparticles on the collector.

In certain embodiments, each suspension is injected through the syringe pump at a flow rate ranging from 0.1 mL/hr to 5 mL/hr, or preferably 2 mL/hr to 3 mL/hr.

In certain embodiments, each nozzle is pointed to the collector at an angle between 30° and 80°, or preferably between 50° and 70° with respect to a direction from the reservoir to the collector. More preferably, each nozzle is pointed to the collector at an angle around 60° with respect to the direction from the reservoir to the collector to get uniform dispersion of microparticles.

In certain embodiments, the working distance between the nozzles and the collector are between 50 and 350 mm, or preferably between 120 and 150 mm. In certain embodiments, the voltage applied between a needle of a spraying device and the collector can be between 1 and 50 kV, or preferably between 25 and 30 kV.

Regarding the free-surface electrospinning setup, in certain embodiments, the rotating speed of the cylindrical electrode is optimized between 1 and 140 rpm, or preferably between 80 and 100 rpm, to tailor the thickness of nanofiber mat. In certain embodiments, the distance between the cylinder and substrate is between 5 and 30 cm, or preferably between 15 and 20 cm. The voltage applied between the electrode and collector is adjusted to between 1 and 50 kV, or preferably between 30 and 35 kV.

In certain embodiments, acetone, chloroform, DMF, dichloromethane (DCM), formic acid (FA), methanol (MeOH) or pyridine is used as a solvent for forming the suspension.

A suitable solvent or mixture of solvents is selected according to the polymer chosen. In certain embodiments, polyamide-6 (PA-6) or PA-66 is dissolved in a mixture of formic acid and acetic acid at room temperature with a 500-rpm stirring. The polymer solution is subjected to free-surface electrospinning for fabricating nanofibers. Both of these polymers can also be dissolved in pure 2,2,2-trifluoroethanol (TFE) or a mixture of TFE and dimethylformamide (DMF) with gentle stirring overnight. The mixture can be subjected to an electrospinning setup configuring with multiple nozzles.

In certain embodiments, for fabricating cellulose acetate nanofibers, the polymer powders are dissolved in either a single solvent system or a mixed solvent system. The single solvent systems include acetone, chloroform, DMF, dichloromethane (DCM), formic acid (FA), methanol (MeOH) and pyridine. The mixed solvent systems include cetone-dimethylacetamide (DMAc), chloroform-MeOH and DCM-MeOH. Polyvinylidene fluoride (PVDF) or its copolymer such as poly(vinylidene fluoride)-co-hexafluoropropylene (PVDF-HFP) can be dissolved in DMF at a specific concentration. Thermoplastic polyurethane (TPU) and polystyrene (PS) solutions can be prepared in a similar way. Different concentrations can be tried to get the most desirable nanofibers. To increase the conductivity and improve the electrospinnability of these polymer solutions, some organo-soluble salts, such as triethylammonium bromide (TEAB) or benzyltriethylammonium chloride (BTEAC), can be added as additives. They may be added as additives to increase the conductivity of the polymer solutions. Polyvinyl alcohol (PVA) or polyethylene oxide (PEO) can be dissolved in deionized water while chitosan can be dissolved in diluted acetic acid (AA) with different concentrations.

Accordingly, a roll-to-roll system can be employed by the present method to collect the particle-coated fibers, meaning that the particle-coated fibers can be collected continuously in form of a roll having a length of a few hundred meters, thereby enhancing the scalability in mass production.

The free-surface electrospinning can be employed to generate fibers and polymer solution can be evenly distributed onto the spinning electrode, thus forming homogeneous fibers, thereby improving the homogeneity of the particle-coated fibers.

The needles for spraying microparticles can be tilted at the optimized angle. It is noted that charge repulsion will occur if the angle is too small while the overlapping area between the sprayed microparticles and the electrospun nanofibers is too small if the angle is too high. The tilted needle configuration in the present method can achieve a balance between the aforementioned two matters. It is expected that the microparticles will be in contact with the polymer jet before complete evaporation of solvent and solidification of the jet, thus improving the adhesiveness between the microparticles and the nanofibers.

The adhesiveness between fibers and particles can be substantially enhanced by the present method. An air blower can be employed to generate air flow to increase the spiraling path of the polymer jet, thus increasing the area covered by the electrospun fibers. As a result, the electrospun nanofibers can be effectively served as a scaffold for holding microparticles.

A membrane comprising a scaffold of particle-coated fibers prepared by the present method can be used for removing ethylene, formaldehyde, nitrogen oxides, solvent vapors, carbon monoxide (CO), hydrocarbons (HC) and nitrogen oxides (NOx). The membrane can have a thickness between 0.5 mm and 1.2 mm, or preferably between 0.8 mm and 0.9 mm.

According to certain embodiments, the method described above can form a membrane made of microparticle-crowded nanofibers. The membrane comprises layers of sparse nanofibers crowed with bunches of microparticles. The diameter of the nanofiber is 100-200 nm. The pore size of sparse nanofiber is 2-5 μm. The microparticles with a diameter of 1-2 μm are crowded around the nanofibers. One of the applications of the membrane is to degrade or adsorb undesirable gases. For example, the microparticle can be catalysts such as titanium dioxide for degrading formaldehyde. It can also be adsorbents such as zeolite for adsorbing the ethylene. It can also be metal oxides such as copper oxide or zinc oxide for killing bacteria and viruses. The nanofibers are made of polymers such as polycaprolactone (PCL).

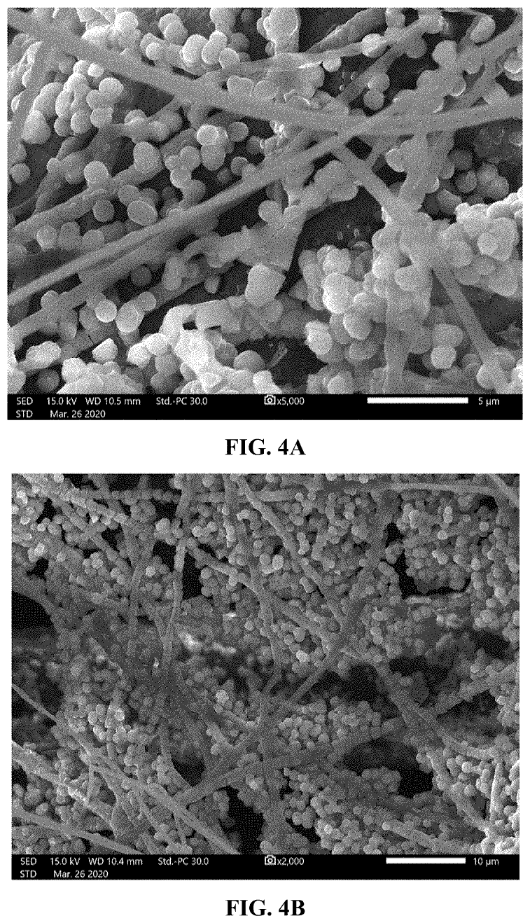

FIGS. 4A and 4B are SEM images showing zeolite microparticle-crowded polycaprolactone nanofibers.

The air permeability of polycaprolactone nanofiber membrane before and after incorporation of zeolite microparticles was tested and the results are shown in Table 1.

TABLE 1

| | Air permeability |
|---|---|
| Polycaprolactone nanofiber membrane before | 36.6 cm³/cm²/s |
| incorporation of zeolite microparticles | |
| Polycaprolactone nanofiber membrane after | 37.5 cm³/cm²/s |
| incorporation of zeolite microparticles | |

According to certain embodiments, the ethylene removal efficiency of zeolite microparticle-crowded polycaprolactone nanofibers formed by the present method is 52.4% within 15 minutes.

According to certain embodiments, the formaldehyde catalysis efficiency of titanium dioxide microparticle-crowded polycaprolactone nanofibers formed by the present method is 50% within 8 hours.

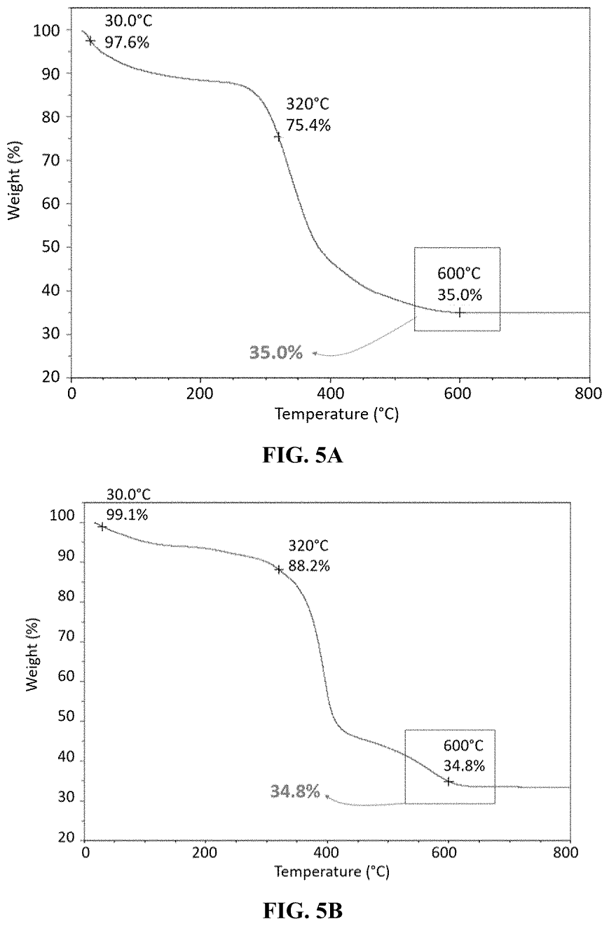

FIGS. 5A and 5B show a thermogravimetric analysis (TGA) of a microparticle-coated nanofibrous membrane prepared by the present method before and after ethylene removal according to certain embodiments. The micro-particles of the membrane comprise zeolite/silver catalyst and the nanofiber of the membrane comprises polycaprolactone (PCL). The weight proportion of micro-particles with respect to nanofibers of the microparticle-coated nanofibrous membrane before and after ethylene removal are calculated and shown in Table 2.

TABLE 2

| | | | Weight proportions of |
|---|---|---|---|
| | Percentage of | Percentage of | microparticles with |
| | microparticles | nanofiber | respect to nanofibers |
| Before | 35.0% | 65.0% | 35.0%/65.0% = 53.84% |
| ethylene | | | |
| removal | | | |
| After | 34.8% | 65.2% | 34.8%/65.2% = 53.37% |
| ethylene | | | |
| removal | | | |

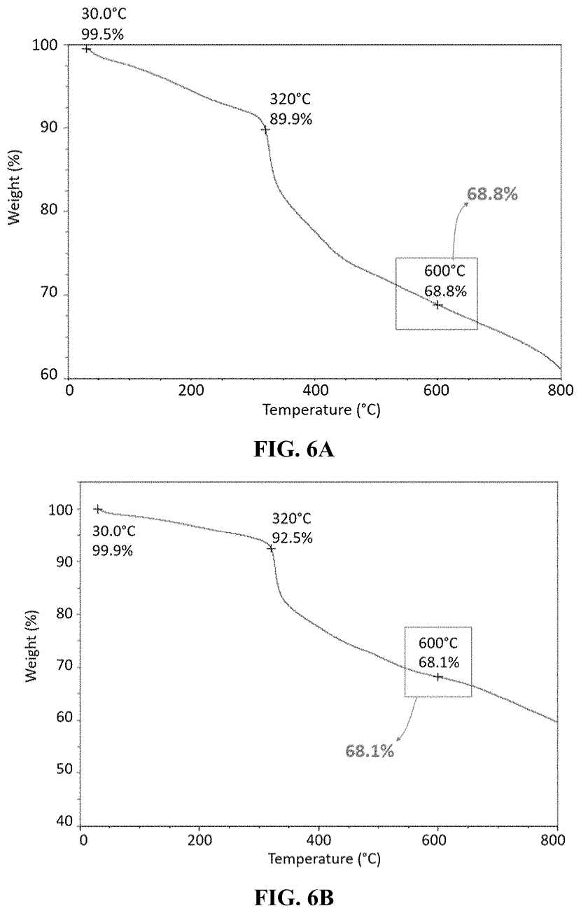

FIGS. 6A and 6B show a thermogravimetric analysis (TGA) of a microparticle-coated nanofibrous membrane prepared by the present method described above before and after formaldehyde conversion according to certain embodiments. The micro-particles of the membrane comprise manganese dioxide (MnO₂) and the nanofiber of the membrane comprises PCL. The weight proportion of micro-particles with respect to nanofibers of this gas converter membrane before and after formaldehyde conversion process are calculated and shown in Table 3.

TABLE 3

| | | | Weight proportions of |
|---|---|---|---|
| | Percentage of | Percentage of | microparticles with |
| | microparticles | nanofiber | respect to nanofibers |
| Before | 68.8% | 31.2% | 68.8%/31.2% = 220.5% |
| ethylene | | | |
| removal | | | |
| After | 68.1% | 31.9% | 68.1%/31.9% = 213.5% |
| ethylene | | | |
| removal | | | |

### Example 1

The method described above prepared a sample 1 of nanofibers electrospun from 12% of polycaprolactone (PCL) dissolved in a mixture of formic acid (FA) and acetic acid (AA) [FA:AA=1:2] and coated with 5% zeolite/Ag microparticles for removing ethylene.

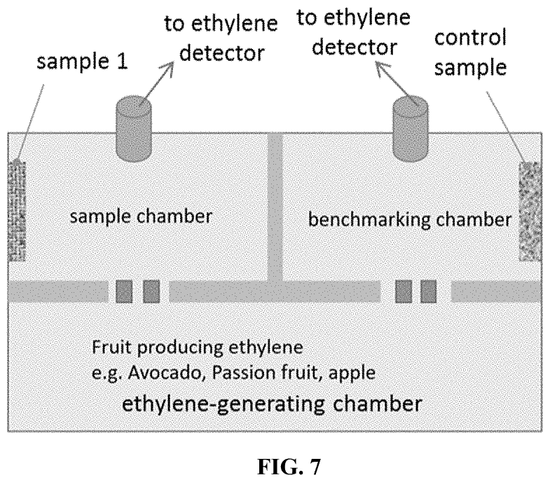

The experimental setup (as shown in FIG. 7) for testing ethylene removal included a sample chamber, a control chamber and an ethylene-generating chamber. Different types of fruits (including avocado, passion fruit and apple) capable of generating ethylene were kept in the ethylene-generating chamber. The generated ethylene was able to diffuse to the sample chamber and the control chamber respectively through small channels, resulting in the same ethylene concentration in both chambers in the beginning of the test. A commercially available ethylene removal material having a brand name “It's Fresh” was used as a control sample. The sample 1 and the control sample were placed in the sample chamber and the control chamber respectively. Table 4 shows the removal efficacy of the sample 1 and control sample.

TABLE 4

| | Ethylene | Ethylene removal |
|---|---|---|
| | concentration (ppm) | efficacy (%) |
| Initial (at 0 hr) | 79.8 | |
| Sample 1 (after 6 hr) | 18.1 | (79.8-18.1)/79.8 = 77.3% |
| Control sample (after | 49.8 | (79.8-49.8)/79.8 = 37.6% |
| 6 hr) | | |

As shown in Table 1, the ethylene removal efficacy of the sample 1 is much higher than that of the control sample.

### Example 2

The method described above prepared a sample 2 of nanofibers electrospun from 10% of polyacrylonitrile (PAN) dissolved in dimethylformamide (DMF) and coated with 20% manganese dioxide (MnO₂) microparticles for removing formaldehyde.

The experimental details for testing formaldehyde removal are described as follows. A formaldehyde solution with a concentration of 37% was prepared and formaldehyde gas was generated by evaporation of the formaldehyde solution in a chamber. A formaldehyde removal material (i.e., Philips's Pureburg® filter) was used as a control experiment. The sample 2 was arranged in a product form. The formaldehyde concentration was measured by WP6900 formaldehyde detector. The formaldehyde removal efficacy of the sample 2 and the control sample was calculated and shown in Table 5.

TABLE 5

| Formaldehyde | Control | | |
|---|---|---|---|
| concentration (mg/m³) | environment | Sample 2 | Control sample |
| Initial (at 0 hr) | 1.243 | 1.374 | 1.189 |
| After 8 hrs | 1.237 | 0.302 | 0.688 |
| Removal efficacy | 0.5% | 78.0% | 42.1% |

For the sample 2, the initial formaldehyde concentration was 1.374 mg/m³. After 8 hours, the formaldehyde concentration was 0.302 mg/m³. The formaldehyde removal efficacy of the sample 2 was 78.0%. For the control sample, the initial formaldehyde concentration was 1.189 mg/m³. After 8 hours, the formaldehyde concentration was 0.668 mg/m³. The formaldehyde removal efficacy of the control sample was 42.1%.

Thus, it can be seen that an improved particle-coated fiber and method for forming the same have been disclosed which eliminates or at least diminishes the disadvantages and problems associated with prior art products and methods.

Although the invention has been described in terms of certain embodiments, other embodiments apparent to those of ordinary skill in the art are also within the scope of this invention. Accordingly, the scope of the invention is intended to be defined only by the claims which follow.

What is claimed is:

1. A method for forming a particle-coated fiber, the particle-coated fiber comprising a fiber and particles coated on the fiber, the method comprising:
providing a suspension comprising the particles;
providing a polymer solution for forming the fiber;
electrospraying the suspension toward an area of a collector; and
during the electrospraying of the suspension, electrospinning the polymer solution into the fiber and directing the fiber toward the area so as to meet with the suspension on the area and on the way to the area such that the particles are coated on the fiber during and after the formation of the fiber thereby forming the particle-coated fiber on the area.

2. The method of claim 1, wherein the step of electrospraying the suspension toward the area comprises a spraying direction having an angle between 50° and 70° with respect to a direction from a container for containing the polymer solution to the area.

3. The method of claim 1, wherein the step of electrospraying the suspension toward the area comprises using one or more spraying devices to electrospray the suspension toward the area.

4. The method of claim 3, wherein each of the one or more spraying devices is configured to have a spraying direction having an angle between 50° and 70° with respect to a direction from a container for containing the polymer solution to the area.

5. The method claim 1, wherein the step of electrospraying the suspension toward the area comprises applying a voltage between a spraying device containing the suspension and the area.

6. The method of claim 1, wherein the polymer solution is electrospun into the fiber by free-surface electrospinning or needle-type electro spinning.

7. The method of claim 1, wherein the step of electrospinning the polymer solution into the fiber comprises: rotating a drum partially immersed in the polymer solution; and applying a voltage between the drum and the area.

8. The method of claim 1, wherein the step of electrospinning the polymer solution into the fiber and directing the fiber to the area comprises: applying a voltage between the polymer solution and the area.

9. The method of claim 1 further comprising generating an airflow between a container for containing the polymer solution and the area.

10. The method of claim 9, wherein the airflow has an airflow direction being in parallel with the area.

11. The method of claim 10, wherein the airflow moves back and forth along the airflow direction.

12. The method of claim 1 further comprising moving the collector.

13. The method of claim 12, wherein the collector is moved by an unwinding/rewinding system.

14. The method of claim 1, wherein the collector is an aluminum foil, an antistatic nonwoven or a siliconized paper.

15. The method of claim 1, wherein the step of providing the suspension comprises dispersing the particles in a solvent.

16. The method of claim 1, wherein each of the particles is inorganic, has a diameter between 1 and 100 μm and comprises a gas absorbent or a catalyst.

17. The method of claim 1, wherein the polymer solution is prepared by dissolving a polymer or a blended of polymers in a solvent or a mixture of solvents.

18. The method of claim 1, wherein the polymer solution comprises polyacrylonitrile, poly(vinylidene fluoride), poly(vinylidene fluoride-co-hexafluoropropylene), polyvinylpyrrolidone, poly(vinyl alcohol), poly(ethylene oxide), polysulfone, polyethersulfone, poly(methyl methacrylate), or polyurethane, polyamide 6.

19. A particle-coated fiber being formed by the method of claim 1.

20. A method for forming a scaffold of particle-coated fibers, each of the particle-coated fibers comprising a fiber and particles coated on the fiber, the method comprising:
providing a suspension comprising the particles;
providing a polymer solution for forming the fibers;
electrospraying the suspension toward an area of a collector; and
during the electrospraying of the suspension, electrospinning the polymer solution into the fibers and directing the fibers toward the area so as to meet with the suspension on the area and on the way to the area such that the particles are coated on the fibers during and after the formation of the fibers thereby forming the scaffold.
